(19) United States
(12) Patent Application Publication
(10) Pub. No.: US 2003/0196538 A1
(43) Pub. Date: Oct. 23, 2003

(54) MUSICAL INSTRUMENT STRINGS

(76) Inventors: Guennadi Katchanov, St. Louis, MO (US); Vicki O'Connor, St. Louis, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/127,274

(22) Filed: Apr. 22, 2002

(51) Int. Cl. G10D 3/00

(52) U.S. Cl. 84/297 S

(57) ABSTRACT

The present invention relates generally to musical instrument strings, and in particular to improved musical instrument strings for guitars and the like, having longitudinal wrappings and/or surface contours to provide improved tactile response without adversely affecting the string tonal quality or producing undesirable noise. Improved musical instrument strings may have cores of metal wire, or may be composed of a synthetic material having a longitudinally contoured exterior surface and optionally a core impregnated with either a non-random dispersion of additive particles.

### CROSS-REFERENCE TO RELATED APPLICATIONS

None.

### STATEMENT REGARDING FEDERALLY SPONSORED RESEARCH

Not Applicable.

### BACKGROUND OF THE INVENTION

The present invention relates generally to plastic treble guitar strings modified to have improved sustain, volume, tone and also to low register guitar strings that are devoid of any helical windings on the outer surface that cause noise when a player slides fingers along the strings.

Currently, the majority of low register guitar strings consist of a metal, silk or nylon core around which another piece of round metal wire is wound in a helix pattern. Examples of such strings may be found in U.S. Pat. No. 5,984,226 to Sanderson; U.S. Pat. No. 5,913,257 to Schaller et al., U.S. Pat. No. 5,892,166 to Sanderson; U.S. Pat. No. 5,693,899 to Kalosdian; U.S. Pat. No. 5,535,658 to Kalosdian; U.S. Pat. No. 4,854,213 to Infeld; and U.S. Pat. No. 4,135,429 to Heyne.

A disadvantage of this design is that the ridges formed by the helical windings produce an undesirable “squeaking” noise when a musician's fingers are moved or shifted along the strings as the instrument is played. This undesirable noise is produced because the helical windings are essentially perpendicular to the string longitudinal axis, producing hills and crevices which create a rough surface to the string.

An attempt to overcome this problem has been to either grind the surface of the outer winding to produce a “ground wound string” or to otherwise flatten the exterior surface of the string before or after the winding has been applied. Examples of such strings can be found in U.S. Pat. No. 4,365,534 to Rendell and in U.S. Pat. No. 4,326,444 to Markley. A problem with grinding the string is that the mass of the string is reduced by the grinding process, resulting in the use of larger wires to compensate. Such changes in wire dimensions require changes in the wire core diameter and in the amount of tension required to bring the wire into pitch, resulting in adverse affects on the intonation of the string. Similarly, fattening surfaces of the winding wire either before or helically wrapping about the core string fails to eliminate the undesirable noise characteristics of wound strings while preserving tonal quality.

Another solution which has been applied to musical instrument strings is to utilize a winding wire having a rectangular cross section as the outer winding of the string to provide what is known as a “flat wound” string. Examples of such “flat wound” strings may be seen in U.S. Pat. No. 5,907,113 to Hebestreit et al.; U.S. Pat. No. 5,883,319 to Hebestreit et al.; U.S. Pat. No. 5,801,319 to Hebestreit et al.; and U.S. Pat. No. 5,610,348 to Aladin et al. Flat wound strings help to reduce the undesirable “squeaking” noise problem, but they do not get rid of it completely; and they also produce a “deader” sound as a result.

Majority of treble string for Spanish (flamenco) or classical guitars (strings #1, 2, & 3 corresponding to notes E, B, and G in standard tuning) consist of smooth nylon monofilaments. Generally nylon monofilaments have lighter tension than their metal counterparts and generally are easier to play. In addition nylon monofilaments produce a different musical tone, softer and more mellow then steel strings. Four major complaints related to nylon strings are commonly heard from musicians: 1) nylon strings do not sustain sound as much as steel strings do; 2) nylon strings are not as loud as steel strings are; 3) currently there are no nylon strings on the market that are compatible with electromagnetic pickups; and 4) the majority of nylon strings are either translucent (clear nylon) or black colored nylon. Both clear and black nylon strings are fairly hard to see on a black or dark brown finish of the neck of a classical or flamenco guitar. This in turn, creates problems for novice musicians as they must constantly watch their hand movement during fretting note(s). Also, even advanced musicians sometimes have problems with observing their hand movements since some recitals are done with the lights dimmed and poor stage lighting. Accordingly, musicians need better visual cues as to their hand position on the guitar neck.

Some attempts have been made to correct for certain sonic imperfections in nylon treble monofilaments. U.S. Pat. No. 5,610,348 to Aladin et al. offers several solutions for manufacturing treble (or discant in the terminology of the inventor) strings using the same principle as are used to manufacture low register guitar stings: helically winding very thin metal wire around the core that consists of groups of very thing nylon filaments and in addition enclosing the entire assembly in a second winding of very thing nylon filament helically wound above metal wire to assure surface nylon finish of the string.

Some attempts have been made to incorporate ferromagnetic materials into a monofilament string. For example, U.S. Pat. No. 5,408,911 to Weiss et al. disclose a nylon or other non-ferromagnetic musical instrument string which is painted with a fluid material comprising a suspension of nickel particles in a solvent, thereby leaving a metallic residue which can be detected by a pickup. Similarly, U.S. Pat. No. 5,578,775 to Ito teaches a process for sheathing a core wire composed of long filaments with a thick mantle of precious metal, such as gold, silver, platinum or the like. Finally, U.S. Pat. No. 3,826,171 to Kaar discloses several types of monofilament musical instrument strings wherein the synthetic monofilament string incorporates a random distribution of ferromagnetic particles or a coil of magnetic wire to act on the field of a magnetic pickup for high-fidelity amplification.

There is a need for a low register musical instrument string that have a smooth metal finish and are completely devoid of helical windings on the exterior so that any “squeaking” noise would be virtually absent during playing. Furthermore, there is a need to improve the musical quality of plastic treble (or upper register) guitar strings by providing greater sustain and volume, use with electromagnetic pickups combined with better tactile feel and better overall esthetic design.

### BRIEF SUMMARY OF THE INVENTION

Among the several objects and advantages of the present invention are:

Provision of a low register musical instrument string which is formed by forcing a molten polymer that contains metal or other heavy particles through a thin walled tube.

The provision of a plastic or similar polymer material musical instrument string in which additive particles are distributed in a non-random pattern;

The provision of a musical instrument string including additive particles composed of metal, metal oxides, coloring agents and luminescent agents.

The provision of a plastic or similar low-tension polymer material musical instrument string in which a thin metal core, comprising either solid or interrupted segments, is encapsulated in the body of a plastic string;

The provision of a plastic or similar low-tension polymer material musical instrument string in which a core plastic string is provided with a plurality of longitudinal ridges or corrugations on an exterior surface; and

The provision of a plastic string that contains two or more of the above mentioned features: a combination of metal core with various particles and or colors and luminescent agents. In addition, this design could have a longitudinally textured surface.

Briefly stated, in a first embodiment a musical instrument string of the present invention eliminates undesirable noise by providing either: a) an absolutely smooth exterior surface; or b) an exterior surface that is textured longitudinally.

In a second embodiment, a musical instrument string of the present invention incorporates the use of additive particles such as metals, metal oxides, coloring and luminescent agents to improve tonal quality, facilitate the use with electromagnetic pick-ups and also to improve the overall esthetic design of the string. In addition, a longitudinally textured exterior surface will facilitate certain legato techniques.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective view of a segment of prior art musical instrument string, illustrating a conventional “round wound” helical winding about a central core wire;

FIG. 2 is a perspective view of a segment of prior art musical instrument string, illustrating a conventional “flat wound” rectangular cross-section winding wrapped about a central core wire;

FIG. 3 is a perspective view of a segment of a first embodiment of the musical instrument string of the present invention, wherein a central polymer core is encased in a thin wall metal tubing;

FIG. 4 is a cross sectional view of the musical instrument string of FIG. 3;

FIG. 5A is a perspective view of a segment of a third embodiment of the musical instrument string of the present invention, wherein a central core is encased in a thin wall tubing having an exterior surface textured with a plurality of longitudinal ridges;

FIG. 5B is a variation of the embodiment shown in FIG. 5A, wherein the exterior surface of the tubing is textured with a plurality of longitudinally aligned curved surfaces;

FIG. 6 is a perspective view of a fourth embodiment of the musical instrument string of the present invention, wherein a central core is encased within a thin walled tube having a longitudinally contoured exterior surface;

FIG. 7A is a perspective view of a segment of plastic musical instrument string of the present invention encapsulating a loosely dispersed core of additive particles;

FIG. 7B is an alternate embodiment of the plastic musical instrument string of FIG. 7A, wherein said core comprises a high density of additive particles;

FIG. 7C is a second alternate embodiment of the plastic musical instrument string of FIG. 7A, wherein said core incorporates a cylindrical dispersion of additive particles;

FIG. 8A is a perspective view of a segment of synthetic musical instrument string of the present invention encapsulating a metallic core wire segment;

FIG. 8B is a first alternate embodiment of the synthetic musical instrument string of FIG. 8A, encapsulating a plurality of metallic core wire segments of moderate length;

FIG. 8C is a second alternate embodiment of the synthetic musical instrument string of FIG. 8A, encapsulating a plurality of metallic core wire segments of short length;

FIG. 8D is a third alternate embodiment of the synthetic musical instrument string of FIG. 8A, encapsulating a plurality of metallic core spheres abutting each other along the string axis;

FIG. 9A is a perspective view of a segment of synthetic musical instrument string having a longitudinally contoured exterior surface as seen in FIG. 5B, combined with a loosely dispersed core of additive particles as seen in FIG. 7A;

FIG. 9B is a perspective view of a segment of synthetic musical instrument string having a longitudinally contoured exterior surface as seen in FIG. 5B, combined with a cylindrically dispersed core of additive particles as seen in FIG. 7C;

FIG. 9C is a perspective view of a segment of synthetic musical instrument string having a longitudinally contoured exterior surface as seen in FIG. 5B, combined with a dense core of additive particles as seen in FIG. 7B;

FIG. 10A is a perspective view of a segment of synthetic musical instrument string encapsulating a loosely dispersed core of additive particles in combination with a plurality of metallic core spheres abutting each other along the string axis;

FIG. 10B is a perspective view of a segment of synthetic musical instrument string encapsulating a loosely dispersed core of additive particles in combination with a metallic core wire segment;

FIG. 10C is a perspective view of a segment of synthetic musical instrument string encapsulating a loosely dispersed core of additive particles in combination with a plurality of metallic core wire segments of short length;

FIG. 11A is a perspective view of a segment of synthetic musical instrument string encapsulating uniformly dispersed additive particles in combination with a plurality of metallic core spheres abutting each other along the string axis;

FIG. 11B is a perspective view of a segment of synthetic musical instrument string encapsulating uniformly dispersed additive particles in combination with a metallic core wire segment;

FIG. 11C is a perspective view of a segment of synthetic musical instrument string encapsulating uniformly dispersed additive particles in combination with a plurality of metallic core wire segments of short length;

FIG. 12A is a perspective view of a segment of synthetic musical instrument string of FIG. 10A encapsulating a loosely dispersed core of additive particles in combination with a plurality of metallic core spheres abutting each other along the string axis and an additional outer layer of additive particles;

FIG. 12B is a perspective view of a segment of synthetic musical instrument string of FIG. 10B encapsulating a loosely dispersed core of additive particles in combination with a metallic core wire segment and an additional outer layer of additive particles; and

FIG. 12C is a perspective view of a segment of synthetic musical instrument string of FIG. 10C encapsulating a loosely dispersed core of additive particles in combination with a plurality of metallic core wire segments of short length and an additional outer layer of additive particles.

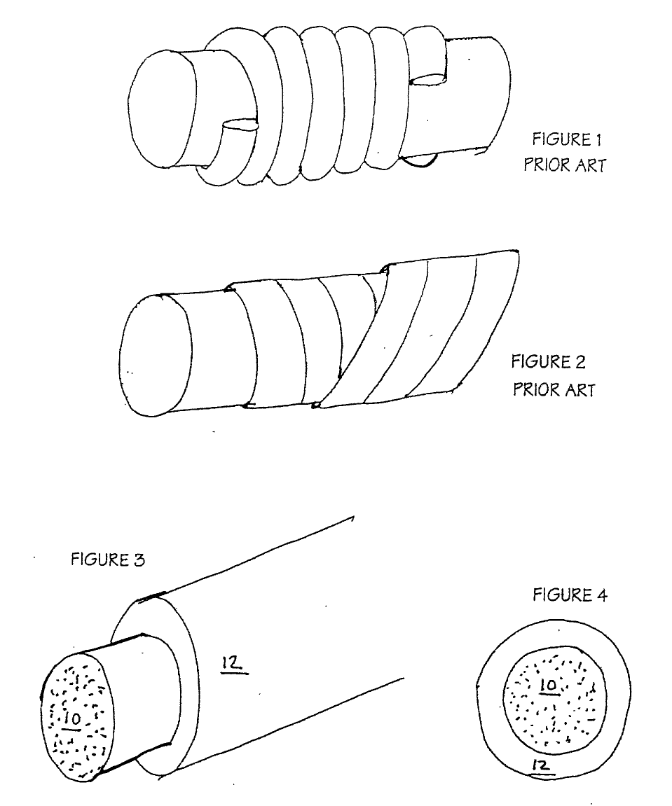

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

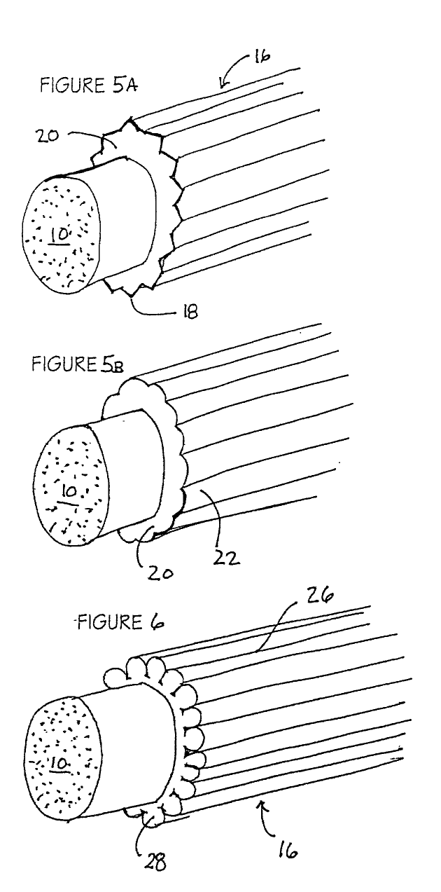

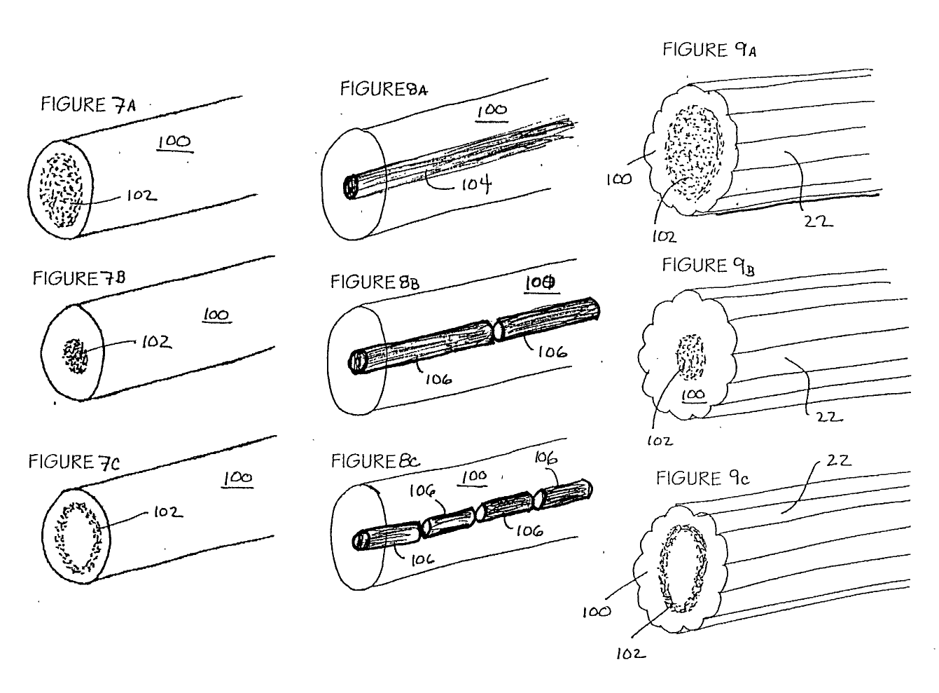

Turing to FIGS. 3 and 4, a first embodiment of the present invention is shown. To eliminate the helical windings of conventional musical instrument strings without reducing the mass of the string, and thereby the musical characteristics thereof, a plastic core material 10 containing heavy particles such as metal or metal oxides is encapsulated within a thin-walled tubing 12. The thin-walled tubing 12 acts as a tensioning member, while the core material 10 acts to increase the vibrating mass of the musical instrument string in the same manner as the conventional helical windings, while simultaneously eliminating the helical ridges and crevices formed thereby.

To facilitate specific techniques known as “legato”, “hammer-on” and “pull-off”, commonly utilized on guitars and other stringed musical instruments, the exterior surface 16 of the musical instrument string may be provided with a plurality of longitudinal ridges and crevices 18, to provide a non-circular cross-sectional area. As seen in FIGS. 5A and 5B, a thin-walled tubing 20, preferably of metal, fitted about the musical instrument string core 10 may be textured in a longitudinal manner by providing a plurality of longitudinally arrayed ridges and crevices 18, or longitudinally arrayed curved surfaces 22.

Turning to FIG. 6, an similar exterior surface configuration may be achieved by providing a plurality of deep longitudinal creases or ridges 26 forming a corrugated pattern in exterior surface 16 of the thin-walled tube 28 through which the string core material 10 passes.

The objective of these deep creases is similar to windings of round wound guitar strings. It is to make parts of the outer shell of the string to “grind” against each other or to “rattle” as do the windings of round wound strings. That in turn should help to preserve a “round wound” tone of the string and at the same time reduce or virtually eliminate finger noise (i.e. “fret noise”).

By carefully selecting metals and alloys for thing walled tubing and filling the tubing with polymer core mixed with particles of metals or their oxides, it is possible to create a new low register string with a desired tone or spectrum of tones.

Turning to FIGS. 7A-7C, alternate designs for a musical instrument string of the present invention are shown. Thin treble strings on guitars and similar plucked or bowed musical instruments are commonly smooth-surfaced monofilament string 100 of various materials, such as metal or synthetic fiber (plastics). Plastic strings are typically under light tension than metal strings, and thus are easier to play. In addition, synthetic fiber strings tend to produce a mellower musical tone, preferred for use with a majority of classical or Spanish guitar treble strings.

To improve upon the ability of synthetic or plastic strings to sustain sound and increase volume, the present invention incorporates a non-random distribution of additive particles 102 within the plastic string 100. The additive particles 102 may be of a ferromagnetic material such as iron, nickel or rare earth metal, suitable for use with electromagnetic pickups. The additive particles 102 may also be a non-magnetic material such as tungsten, metal oxides, or precious metals, useful for altering the musical characteristics of the string, or the additive particles 102 may be a coloring agent, such as paints, dyes (coloring), or luminescent materials, or a combination thereof. For example, luminescent materials, such as those which “glow” in the dark, or “glow” in response to vibratory motion can be utilized to provide enhanced visual effects during the playing of the strings. Incorporating the additive particles 102 within the plastic strings 100 preserves the original “nylon” or “plastic” feel of the plastic string 100, while improving sound quality such as tone and sustain by increasing the mass of the plastic string 100 or appearance by altering the color or luminescent qualities of the plastic string 100.

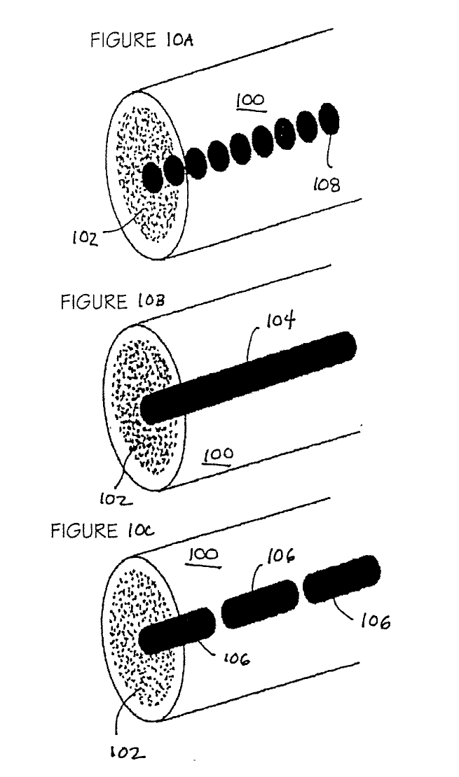

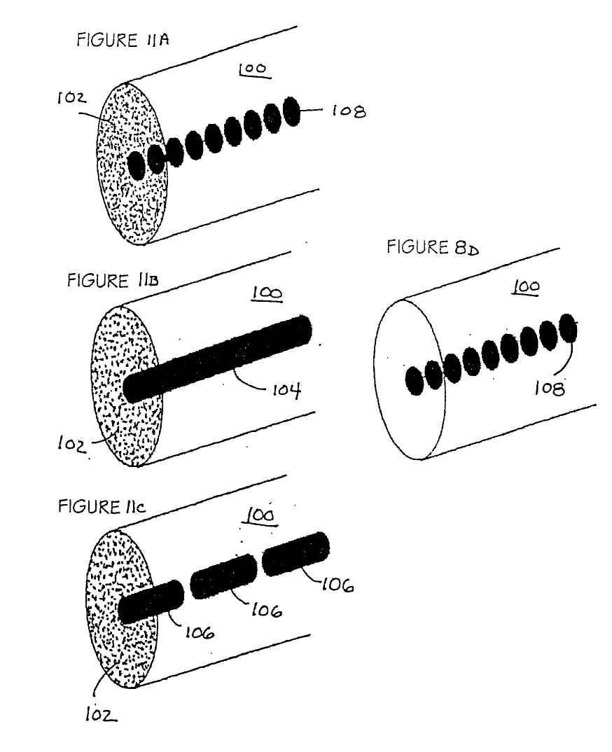

FIG. 8A through FIG. 8D depict an alternative design where a metallic core 104 could be added to the plastic string 100 to increase sustain and volume. The metallic core may consist or a solid wire 104 or may comprise a plurality of wire segments 106 arranged along the longitudinal axis of the synthetic or plastic string 100, as seen in FIG. 8B illustrating wire segments 106 of moderate length and FIG. 8C illustrating wire segments 106 of short length. In a second alternative embodiment, the metallic core may comprise a plurality of spherical metallic elements 108 arranged in abutting relationship along the longitudinal axis of the plastic string 100, as shown in FIG. 8D. When the plastic string 100 is installed in a musical instrument, the individual wire segments 106 shown in FIGS. 8B and 8C and spherical metallic elements 108 are not tensioned members.

Those of ordinary skill in the art will readily recognize the benefits which may be achieved by utilizing a magnetic metal for either the additive particles 102 or the metallic core elements 104, 106, 108 described above. Specifically, the use of a magnetic metal facilitates the use of the improved strings of the present invention with the electromagnetic pickups commonly found in electric guitars and other string musical instruments.

FIG. 10A through FIG. 10C depict a plastic string 100 that has various types of metallic cores (104, 106, and 108) encased by a polymer filled with particles 102 that do not reach the surface of the string. These particles may be regularly or randomly distributed, and consist of metals, metal oxides, ferromagnetic particles, coloring dyes, or various luminescent materials that “glow” in the dark or “glow” in response to vibration. In addition a mixture of two or more various types of particles could be added to the polymer string 100 and used with any of these metallic cores (104, 106, and 108) to attain special combined effects.

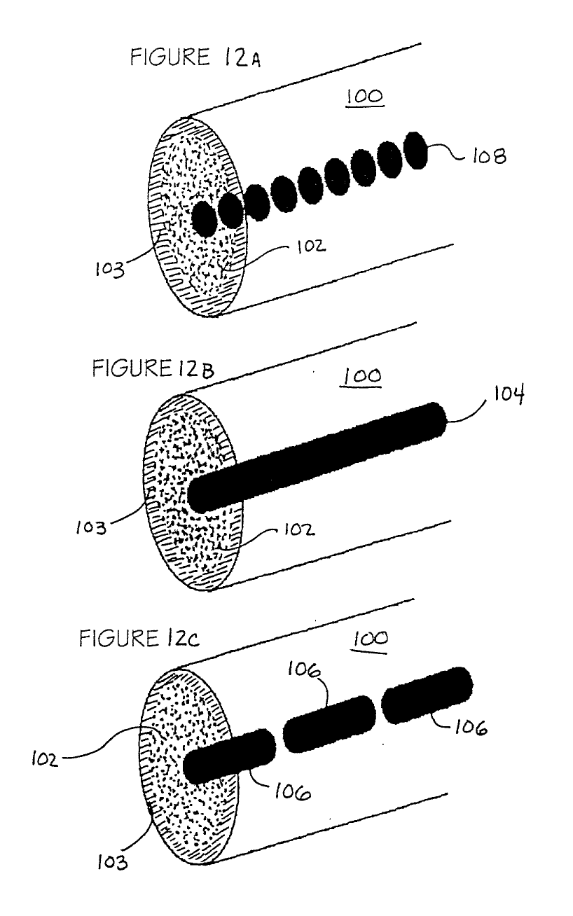

FIG. 11A through FIG. 11C depict another possible design for the plastic string 100 that has various types of metallic cores (104, 106, and 108) encased by a polymer filled with particles that reach the surface of the string. These particles may be regularly or randomly distributed, and consist of metals, metal oxides, ferromagnetic particles, coloring dyes, or various luminescent materials that “glow” in the dark or “glow” in response to vibration. In addition a mixture of two or more various types of particles could be added to the polymer string 100 and used with any of these metallic cores (104, 106, and 108) to attain special combined effects.

FIG. 12A through FIG. 12C depict a plastic string 100 that has various types of metallic cores (104, 106, and 108) incased by a polymer that has a non-random particle distribution in it. The metallic core (104, 106, and 108) is surrounded by a polymer containing a mix of particles 102 of “type A” or a combination of two o even three different types of particles (i.e. type A, B, and C) and in addition the entire assembly is covered with an outer layer of the polymer that is mixed with particles 103 of a different type (i.e. type D and/or E and F) which forms the outer surface of the string 100. These particle types A, B, C, D, E, and F could be A) metals, B) metal oxides, C) ferromagnetic particles, D) coloring dyes, E) various luminescent materials that “glow” in the dark, or F) various luminescent materials that “glow” in response to vibration.

Any of the designs described above in the context of FIGS. 7A-7C, 8A-8D, 10A-10C, 11A-11C, and 12A-12C could be produced with the textured exterior surface as described in FIGS. 9A-9C.

Similarly, it will be recognized that polymer or plastic treble strings 100 of the present invention may be produced using thin plastic polyfilaments encased in a plastic sheath. Such an embodiment could be combined with any of the above mentioned non-random additive particle distributions within the polyfilament plastic string, and in addition, the exterior surface of the plastic sheath may be textured with longitudinally aligned formations such as ridges and crevices 18, 22, or 26, providing a non-circular cross-sectional area. The result is a low-tension plastic string 100 having an increased mass. The increase in mass, and the magnetic properties and appearance of the plastic string 100 may be varied as desired by selecting suitable additive particles 102 or a combination of additive particles for distribution within the plastic string 100.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A string for a string musical instrument that comprises:
a core material having a longitudinal axis.

2. The string of claim 1 wherein said wrapping material comprises a thin-walled tube.

3. The string of claim 2 wherein an exterior surface of said thin-walled tube includes a plurality of crevices arrayed parallel to said longitudinal axis.

4. The string of claim 1 wherein said core material comprises a synthetic polymer containing metal particles.

5. The string of claim 1 wherein said core material comprises a synthetic polymer containing metal oxide particles.

6. The string of claim 1 wherein said wrapping material comprises a metal.

7. The string of claim 1 wherein said wrapping material comprises a metal alloy.

8. A string for a string musical instrument that comprises:
a synthetic material having a longitudinal axis; and
a plurality of additive particles non-randomly distributed within said synthetic material.

9. The string of claim 8 wherein said plurality of additive particles are ferromagnetic.

10. The string of claim 8 wherein said exterior surface of said tensioning material includes a plurality of longitudinal ridges.

11. The string of claim 8 wherein said synthetic material has a non-circular cross section.

12. The string of claim 8 wherein said additive particles have coloring properties.

13. The string of claim 8 wherein said additive particles have luminescent properties.

14. The string of claim 8 wherein said plurality of additive particles are metals.

15. The string of claim 8 wherein said plurality of additive particles are metal oxides.

16. The string of claim 8 wherein said plurality of additive particles includes two or more types of additive particles.

17. A string for a string musical instrument that comprises:
a synthetic material having a longitudinal axis; and
a metallic core.

18. The string of claim 17 wherein said metallic core comprises a plurality of longitudinal segments.

19. The string of claim 17 wherein said synthetic material has a non-circular cross section.

20. The string of claim 17 wherein said metallic core is ferromagnetic.

21. The string of claim 17 wherein said metallic core comprises a plurality of spherical metallic elements arranged in an abutting relationship along said longitudinal axis of said synthetic material.

22. A string for a string musical instrument that comprises:
a synthetic material having a longitudinal axis;
a metallic core; and
a plurality of additive particles distributed within said synthetic material.

23. The string of claim 22 wherein said plurality of additive particles are randomly distributed within said synthetic material.

24. The string of claim 22 wherein said plurality of additive particles are non-randomly distributed within said synthetic material.

25. The string of claim 22 wherein a first portion of said plurality of additive particles are randomly distributed within said synthetic material; and
wherein a second portion of said additive particles are non-randomly distributed within said synthetic material.

26. The string of claim 22 wherein said exterior surface of said synthetic material includes a plurality of longitudinal ridges.

27. The string of claim 22 wherein said synthetic material has a non-circular cross section.

28. The string of claim 22 wherein said plurality of additive particles comprise metals and metal oxides of a non-ferromagnetic nature.

29. The string of claim 22 wherein said plurality of additive particles are ferromagnetic.

30. The string of claim 22 wherein said plurality of additive particles have luminescent properties.

31. The string of claim 22 wherein said plurality of additive particles are color dyes.

32. The string of claim 22 wherein said plurality of additive particles comprise a combination of two or more types of particles.
